(19) United States
(12) Patent Application Publication
(10) Pub. No.: US 2022/0320711 A1
(43) Pub. Date: Oct. 6, 2022

(54) ADJUSTABLE SLOT ANTENNAS

(71) Applicant: Hewlett-Packard Development Company, L.P., Spring, TX (US)

(72) Inventors: Pai-Cheng Huang, Taipei City (TW); Kun-Jung Wu, Taipei City (TW); Chung-Hua Ku, Taipei City (TW); Chin-Hung Ma, Taipei City (TW)

(73) Assignee: Hewlett-Packard Development Company, L.P., Spring, TX (US)

(21) Appl. No.: 17/633,624

(22) PCT Filed: Oct. 4, 2019
(86) PCT No.: PCT/US2019/054871

§ 371 Date: Feb. 8, 2022

(51) Int. Cl. H01Q 1/22; H01Q 13/10; H01Q 3/01; H01Q 9/14

(52) U.S. Cl. CPC H01Q 1/2258; H01Q 13/10; H01Q 3/01; H01Q 9/14

(57) ABSTRACT

Example electronic devices with adjustable antennas as disclosed. In an example, the electronic device includes a housing, and an antenna disposed within the housing. The antenna includes a slot extending between a first conductive surface and a second conductive surface, and a contact clip coupled to the first conductive surface and the second conductive surface so that the first conductive surface is coupled to the second conductive surface through the contact clip. The contact clip is to move along the slot to adjust an operating frequency of the antenna.

### BACKGROUND

Electronic devices may include antennas that facilitate communication with wireless networks. Wireless networks may include local wireless networks (e.g., wireless local area networks—WLAN) such as, for instance, WIFI networks at a home or office, or large or regional networks (e.g., wireless wide area networks—WWAN) such as, for instance, telecommunication networks. In some instances, an antenna may comprise a slot(s) that determines a resonant operating frequency with which the antenna transmits and receives wireless signals.

### BRIEF DESCRIPTION OF THE DRAWINGS

Various examples will be described below referring to the following figures:

FIG. 1 is a perspective view of an electronic device including an adjustable antenna according to some examples;

FIG. 2 is a schematic view of the adjustable antenna of the electronic device of FIG. 1 according to some examples;

FIGS. 3 and 4 are schematic views of the adjustable antenna of FIG. 2 with a contact clip of the adjustable antenna disposed in different positions according to some examples;

FIG. 5 is a cross-sectional view taken along section A-A in FIG. 2 according to some examples;

FIG. 6 is another cross-sectional view taken along section A-A in FIG. 2 according to some examples;

FIG. 7 is an enlarged top view of the contact clip of the adjustable antenna of FIG. 2 according to some examples; and

FIG. 8 is a schematic diagram of the adjustable antenna of the electronic device of FIG. 1 according to some examples.

### DETAILED DESCRIPTION

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

In the following discussion and in the claims, the terms “including” and “comprising” are used in an open-ended fashion, and thus should be interpreted to mean “including, but not limited to . . . .” Also, the term “couple” or “couples” is intended to be broad enough to encompass both indirect and direct connections. Thus, if a first device couples to a second device, that connection may be through a direct connection or through an indirect connection via other devices, components, and connections. In addition, as used herein, the terms “axial” and “axially” generally refer to positions along or parallel to a central or longitudinal axis (e.g., central axis of a body or a port), while the terms “lateral” and “laterally” generally refer to positions located or spaced to the side of the central or longitudinal axis.

As used herein, including in the claims, the word “or” is used in an inclusive manner. For example, “A or B” means any of the following: “A” alone, “B” alone, or both “A” and “B.” In addition, when used herein including the claims, the word “generally” or “substantially” means within a range of plus or minus 10% of the stated value. As used herein, the term “electronic device,” refers to a device that is to carry out machine readable instructions, and may include internal components, such as, processors, power sources, memory devices, etc.

As previously described above, electronic devices may comprise an antenna (e.g., such as a slot antenna) that facilitates communication with a wireless network (e.g., WLAN, WWAN, etc.). Wide area networks (e.g., telecommunication networks) may have different operating frequency bands depending on the location of the network (e.g., country, state, region, etc.), the network provider (e.g., such as a cellular network provider), etc. Thus, a given electronic device may have a plurality of different slot antennas to enable the electronic device to communicate with different wide area networks, each antenna having a different slot length. Incorporating multiple slot antennas with different slot lengths into an electronic device reduces manufacturing efficiency and increases costs. Accordingly, examples of electronic devices disclosed herein include slot antennas that have adjustable slot sizes and, thus, adjustable operating frequencies, so that a given antenna may be used to communicate with a variety of different wide area networks at different frequencies.

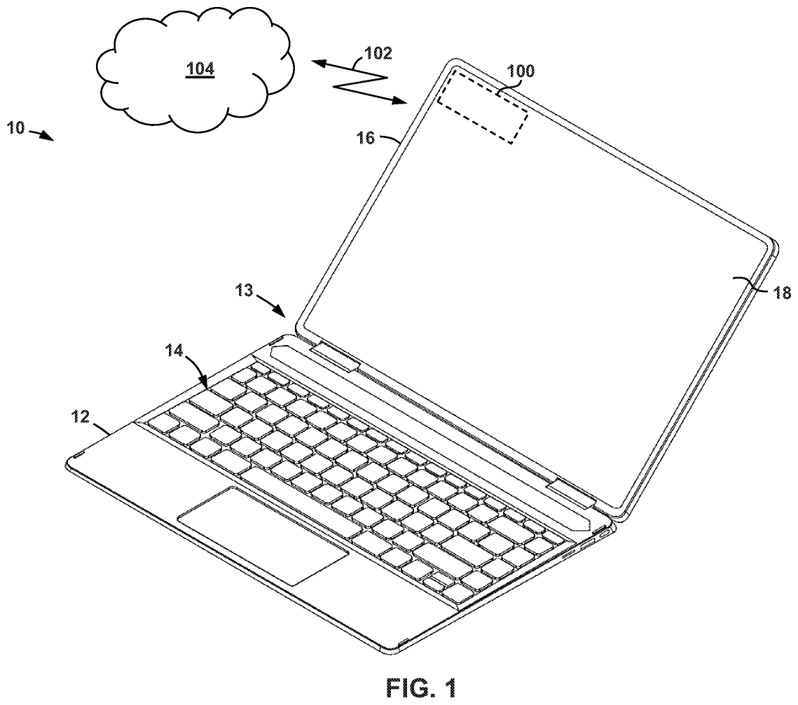

Referring now to FIG. 1, an electronic device 10 according to some examples is shown. In this example, electronic device 10 is a laptop computer that includes a first housing member 12 rotatably coupled to a second housing member 16 at a hinge 13. The first housing member 12 includes a user input device, such as, for example, a keyboard 14. The second housing member 16 includes a display 18 (e.g., a liquid crystal display (LCD), a plasma display, organic light emitting diode (OLED) display, etc.) that is to generate images for viewing by a user (not shown) of the electronic device 10.

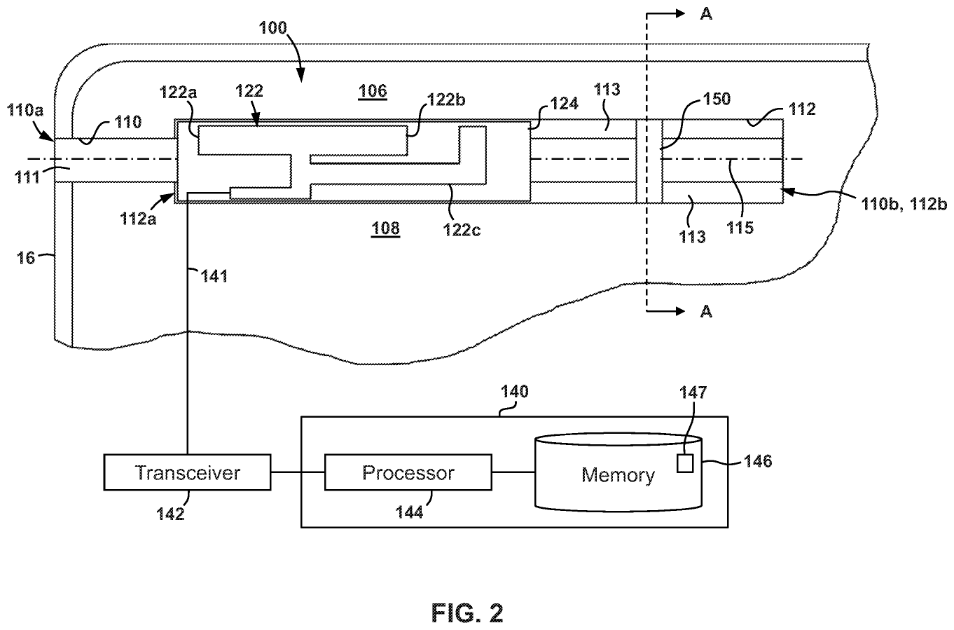

In other examples, electronic device 10 may comprise another type of electronic device (that is, other than a laptop computer as shown in FIGS. 1 and 2). For instance, in other examples, electronic device 10 may comprise any of the other electronic devices described above (e.g., a tablet computer, smartphone, desktop computer, server, etc.).

In addition, electronic device 10 includes an adjustable slot antenna 100 (generally referred to herein as an “antenna 100”) that is to send and receive wireless signals 102 to and from, respectively, a wireless network 104. In some examples (e.g., the example of FIG. 1), the antenna 100 is disposed within the second housing member 16. In particular, in some examples, the antenna 100 is partially or totally disposed under the display 18 (or some portion or layer of the display 18). However, antenna 100 may be placed in any suitable location within electronic device 10 (e.g., such alternative locations within second housing member 16 or within first housing member 12). In addition, in some examples, electronic device 10 may include a plurality of antennas for communicating with a wireless network (or a plurality of wireless networks).

The wireless network 104 may comprise any suitable wireless network, such as those described above (e.g., WLAN, WWAN, etc.). In this example, the wireless network 104 comprises a WWAN network (e.g., a 4G network, a 4GLTE network, a 5G network, etc.). During operations, antenna 100 may receive wireless signals (e.g., wireless signal 102) from wireless network 104, and may send wireless signals (e.g., wireless signal 102) to wireless network 104. As will be described in more detail below, an operating frequency (or operating frequency band) of the antenna 100 may be adjusted by moving a contact clip (or, more simply, a “contact”) along a slot within the antenna 100 so as to tune the antenna 100 for communicating with a desired wireless network (e.g., wireless network 104). Accordingly, a given design for antenna 100 and second housing member 16 may be utilized within electronic device 10 for selectively communicating with a variety of different wireless networks (e.g., wireless networks 104) with different operating frequency bands. In this way, manufacturing costs associated with the electronic device 10 are reduced relative to electronic devices that house multiple antennas with differing slot lengths. Additional details of examples of antenna 100 are now described.

Referring now to FIG. 2, antenna 100 is shown installed within second housing member 16. For convenience, and so as to better show the features of antenna 100, display 18 (see e.g., FIG. 1) is not shown in FIG. 2; however, it should be appreciated that display 18 (or some portion thereof) may be positioned over some or all of the antenna 100 when electronic device 10 is fully assembled. Antenna 100 generally includes a slot 110 that is formed in second housing member 16 along a central or longitudinal axis 115. The slot 110 includes a first or open end 110a at an edge of the second housing member 16, and a second or closed end 110b opposite the open end 110a along axis 115. Slot 110 may be filled (e.g., partially or wholly) with a dielectric material 111 (e.g., such as a polymer, resin, etc.). Because the first end 110a is open or unbounded as previously described above, slot 110 may be referred to herein as an open slot. By contrast, in some examples, first end 110a may be bounded by an additional edge or surface within second housing member 16 (e.g., similar to second end 110b). In these examples, the slot 110 may be referred to as a closed slot.

A recess 112 is formed within the second housing member 16 along slot 110 and axis 115. Recess 112 has a first end 112a and a second end 112b opposite first end 112a. Second end 112b is coincident to closed end 110b of first slot 110 and first end 112a is disposed between the ends 110a, 110b of slot 110. Accordingly, recess 112 has a smaller length along axis 115 (which may be referred to herein as an “axial length”) than slot 110. In addition, recess 112 has a larger width than slot 110 in a radial direction with respect to axis 115 (which may be referred to herein as a “radial width”) so that a pair of ledges or shoulders 113 are formed on either side of first slot 110 that extend axially along recess 112. In this example, the second housing member 16 comprises a conductive material (e.g., such as a metallic material) so that the slot 110 separates a first conductive surface 106 from a second conductive surface 108 of the second housing member 16. Thus, the first conductive surface 106 and the second conductive surface 108 are formed from portions of the second housing member 16.

Referring still to FIG. 2, a substrate 124 disposed within recess 112. In particular, substrate 124 is disposed more proximate the first end 112a than the second end 112b within the recess 112. The substrate 124 may comprise a printed circuit board (PCB) or any other suitable substrate. In some examples, some or all of the substrate 124 may comprise a dielectric material.

A conductive element 122 is disposed on top of the substrate 124. Conductive element 122 may comprise an electrically conductive material, such as a metallic material (e.g., copper, aluminum, gold, silver, platinum, etc.). In addition, conductive element 122 is shaped and designed so as to produce electromagnetic waves having certain desired characteristics (e.g., wavelength, amplitude, etc.) when energized with electric current. In particular, conductive elements may comprise a plurality of portions 122a, 122b, 122c that are sized and shaped to produce desired electromagnetic waves and to receive wireless signals during operations.

In addition, a contact clip 150 is disposed within the recess 112 that is movable along the axis 115 between the ends 112a, 112b during operations. As will be described in more detail below, contact clip 150 is coupled to the first conductive surface 106 and the second conductive surface 108 across slot 110 so that electric current may flow across contact clip 150 between surfaces 106, 108 during operations.

Referring still to FIG. 2, conductive element 122 is coupled to a transceiver 142, which is also coupled to a controller (or control assembly) 140. Controller 140 may be a dedicated controller for antenna 100 or may be included within a main controller or control assembly for electronic device 10. Controller 140 generally includes a processor 144 and a memory 146, which in some examples comprises a non-transitory machine-readable medium.

The processor 144 (e.g., microprocessor, central processing unit, or collection of such processor devices, etc.) executes machine-readable instructions 147 stored in memory 146, and upon executing the machine-readable instructions 147 on memory 146, performs some or all of the actions attributed herein to the processor 144, the controller 140, and/or more generally to the electronic device 10. The memory 146 may comprise volatile storage (e.g., random access memory (RAM)), non-volatile storage (e.g., flash memory, read-only memory (ROM)), or combinations of both volatile and non-volatile storage. Transceiver 142 is coupled to the processor 144 and is to receive and transmit signals (e.g., control signals, etc.) to and from processor 144 as well as to and from antenna 100. Controller 140 is coupled to transceiver 142 and transceiver is additionally coupled to antenna 100 (particularly to conductive element 122) by conductive path 141.

Referring now to FIGS. 1 and 2, during operations, signals are generated by processor 144, processed by transceiver 142, and sent to antenna 100 via conductive path 141. The conductive element 122 may receive the signals and generate a corresponding electromagnetic wave. This electromagnetic wave may then interact with the slot 110, so that the wave may be tuned to a desired resonant frequency for communication with wireless network 104.

In addition, during operations wireless signals 102 may be received from the wireless network 104 by the antenna 100. In particular, the wireless signals 102 may have a frequency that matches the resonant frequency of the antenna 100. Thereafter, the received wireless signals 102 may be conducted (e.g., as electric current) from the antenna 100 to controller 140 via conductive path 141 and transceiver 142.

During the above described operations, the size, shape, and arrangement of the slot 110 may determine an operating frequency for signals that are produced and received by the antenna 100. In particular, the size and shape of the edges of slot 110 may dictate the resonant frequencies for the emitted and received electromagnetic signals 102. Because the contact clip 150 is coupled to the first conductive surface 106 and the second conductive surface 108, it may define an effective end or edge of the slot 110 during operations. Specifically, an effective length of the slot 110 for determining the resonant frequencies of the wireless signals 102 emitted and received by antenna 100 may extend from open end 110a to contact clip 150 along axis 115. Thus, as the position of the contact clip 150 is adjusted along the slot 110, the length of the first slot 110 is also adjusted so that the resonant frequency of the slot 110 (and therefore the operating frequency of the antenna 100) may be changed during operations.

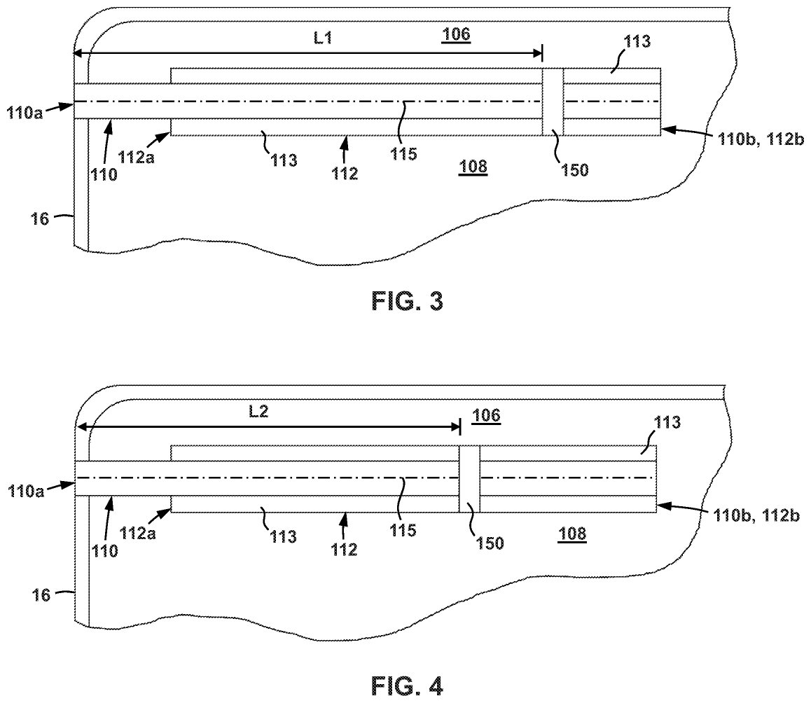

In particular, reference is now made to FIGS. 3 and 4, which depict the contact clip 150 disposed in different positions along the slot 110 (the substrate 124 and conductive element 122 are not shown so as to more clearly depict the slot 110 in FIGS. 3 and 4). Specifically, FIG. 3 shows contact clip 150 placed in a first position along slot 110, so that the slot 110 has a first length L1 from open end 110a to contact clip 150 along axis 115. In addition, FIG. 4 shows contact clip 150 placed in a second position along the slot 110 such that the slot 110 has a second length L2 from open end 110a to contact clip 150 along axis 115. The length L1 is different from (e.g., larger than) the length L2, and thus, the lengths L1, L2 may correspond with different operating frequencies (or different operating frequency bands) for the antenna 100. In particular the operating frequency of antenna 100 may be inversely proportional to the length of slot 110 along axis 115, so that the operating frequency of antenna 100 for the first length L1 shown in FIG. 3 is lower than an operating frequency of antenna 100 for the second length L2 shown in FIG. 4.

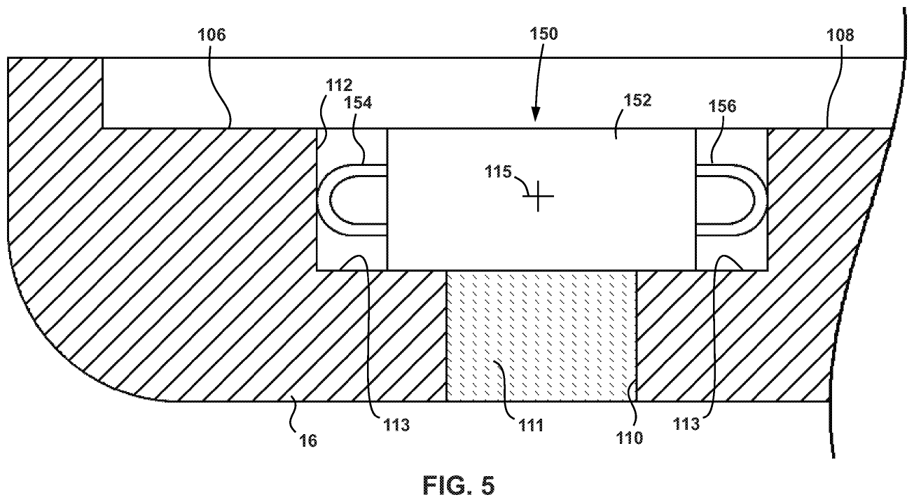

Referring now to FIG. 5, an example contact clip 150 includes a body 152, and a pair of contact members—namely a first contact member 154, and a second contact member 156. Contact clip 150 is disposed within recess 112 so that body 152 is supported (e.g., partially or wholly) by the ledges 113 and spans slot 110. In addition, first contact member 154 may engage with the first conductive surface 106, and second contact member 156 may engage with the second conductive surface 108. In particular, in this example, first contact member 154 and second contact member 156 comprise flat springs that are curved/deformed so as to be biased away from body 152. As a result, first contact member 154 is biased into engagement with first conductive surface 106, and second contact member 156 is biased into engagement with second conductive surface 108. Accordingly, during operations, contact clip 150 may maintain contact between the first conductive surface 106 and second conductive surface 108 (e.g., via contact members 154, 156) so that contact clip 150 may form a conductive bridge between the conductive surfaces 106, 108 during operations as previously described above. Specifically, electric current may be conducted from first conductive surface 106 through first contact member 154, body 152, and second contact member 156 to second conductive surface 108, or may be conducted from second conductive surface 108 through second contact member 156, body 152, and first contact member 154 to first conductive surface 106. Therefore, contact members 154, 156 and body 152 of contact clip 150 may comprise (e.g., partially or wholly) electrically conductive materials.

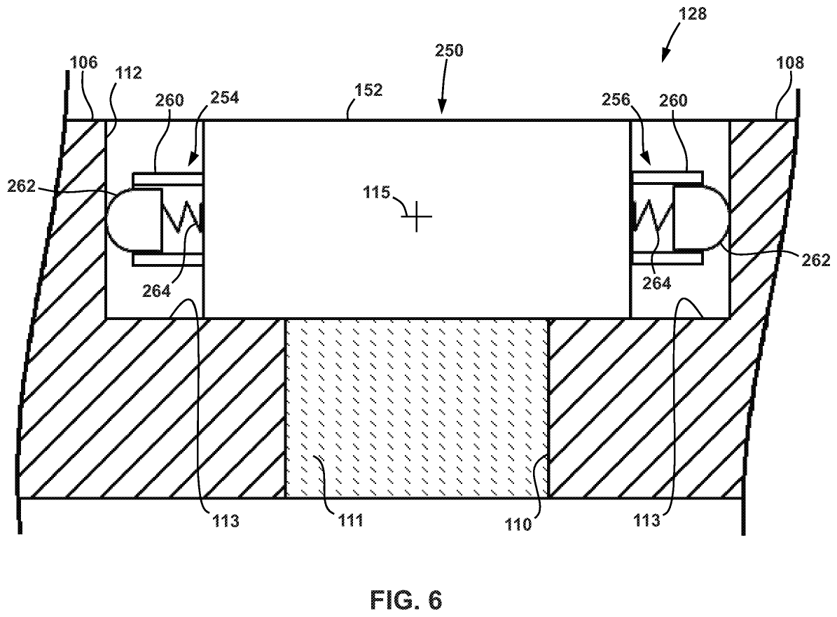

While the first contact member 154 and second contact member 156 have been shown as flat springs in the example of FIG. 5, the first contact member 154 and second contact member 156 may be biased into engagement with the first conductive surface 106 and second conductive surface 108, respectively, utilizing other methods, systems, or devices in other examples. For instance, reference is now made to FIG. 6, which shows another example of contact clip 250 disposed within the recess 112. Contact clip 250 includes body 152 as previously described above for contact clip 150; however, contact clip 250 includes first contact member 254 and second contact member 256 in place of first contact member 154 and second contact member 156, respectively, for contact clip 150 shown in FIG. 5. First contact member 254 and second contact member 256 each comprise a sleeve 260 coupled to body 152, a contact button 262 disposed within sleeve 260, and a biasing member 264 disposed within sleeve 260 between contact button 262 and body 152. Thus, during operations, the contact buttons 262 for each contact member 254, 256 may be biased away from body 152 and toward the corresponding conductive surface 106, 108 via the biasing members 264.

Accordingly, during operations, contact clip 250 may maintain contact between the first conductive surface 106 and second conductive surface 108 (e.g., via contact members 254, 256) so that contact clip 250 may form a conductive bridge between the conductive surfaces 106, 108 during operations as previously described above. Specifically, electric current may flow from first conductive surface 106 through first contact member 254 (e.g., via contact button 262, biasing member 264, and/or sleeve 260), body 152, and second contact member 256 (e.g., via contact button 262, biasing member 264, and/or sleeve 260) to second conductive surface 108, or may be conducted from second conductive surface 108 through second contact member 256, body 152, and first contact member 254 to first conductive surface 106.

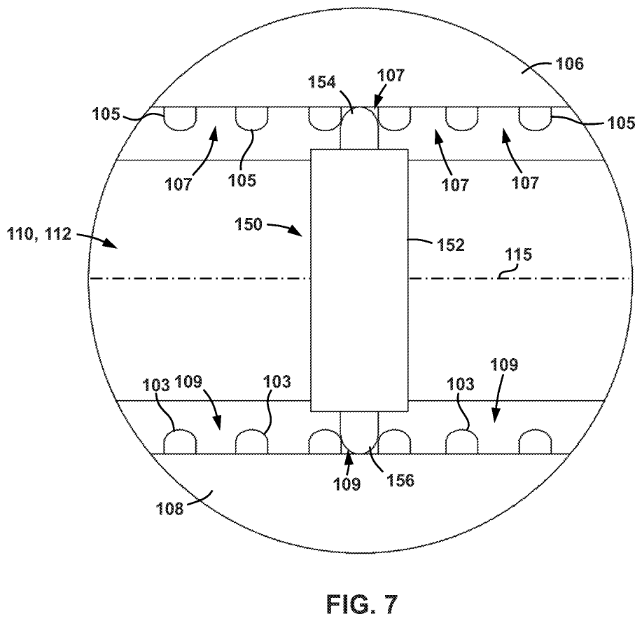

Referring now to FIG. 7, in some examples, the first conductive surface 106 may include a first plurality of notches 107 along the recess 112, and the second conductive surface 108 may include a second plurality of notches 109 along the recess 112. The first plurality of notches 107 may be formed or defined between projections 105 extending from first conductive surface 106 and axially spaced along recess 112, and the second plurality of notches 109 may be formed or defined between projections 103 extending from second conductive surface 108 and axially spaced along recess 112.

During operations, the first contact member 154 (or the first contact member 254 of FIG. 6) may be received within one of the notches 107, and the second contact member 156 (or the second contact member 256 of FIG. 6) may be received within one of the notches 109. Thus, during operations, as the contact clip 150 is moved along the slot 110 and recess 112, the first contact member 154 engages within the notches 107 and the second contact member 156 engages within the notches 109. The notches 107, 109 may establish or define predetermined positions of the contact clip 150 along the recess 112.

In addition, the notches 107, 109 may help to retain the contact clip 150 at a given position along the recess 112. Because the contact members 154, 156 (or the contact members 254, 256 of FIG. 6) are biased radially outward or away from body 152 as previously described, the contact clip 150 may be generally retained within a given pair of the notches 107, 109. In particular, when contact clip 150 is disposed at a given position along recess 112, the first contact member 154 (or the contact button 262 of the first contact member 254 of FIG. 6) may be biased into one of the notches 107, and the second contact member 156 (or the contact button 262 of the second contact member 256 of FIG. 6) may be biased into one of the notches 109. However, when a sufficient force is imparted to the body 152 to move contact clip 150 along axis 115, the contact members 154, 156 (or the contact buttons 262 of the contact members 254, 256 in FIG. 6) may be deflected radially inward toward body 152 so that the contact clip 150 may advance along axis 115 to another corresponding pair of notches 107, 109. Once the contact members 154, 156 are aligned with another corresponding pair of notches 107, 109 at a new position along recess 112, the bias of the contact members 154, 156 (or the bias of the biasing members 264 of contact members 254, 256 in FIG. 6) may once again force the contact members 154, 156 radially outward to once again contact the conductive surfaces 106, 108, respectively.

Referring again to FIGS. 1 and 2, in some examples, the operating frequency of antenna 100 may be tuned during manufacturing of the electronic device 10 to allow for communication between antenna 100 and a particular wireless network 104. In particular, the contact clip 150 may be placed in a predetermined position along the recess 112 so as to achieve a desired, effective length for the slot 110, and thereby a desired resonant frequency of the slot 110 as previously described above. Once the contact clip 150 is placed in a final position along recess 112 and slot 110 for communicating with the desired wireless network 104, the contact clip 150 may be secured in this position via any suitable method. For instance, in some examples, contact clip 150 may be soldered to the first conductive surface 106 and/or the second conductive surface 108, or an attachment member (e.g., a screw, rivet, etc.) may be placed through the contact clip 150 into a suitable surface within the second housing member 16 (e.g., ledges 113, conductive surfaces 106, 108, etc.). Regardless of the method used, once the position of the contact clip 150 is fixed along the recess 112 and slot 110, the operating frequency of the antenna 100 may also be fixed.

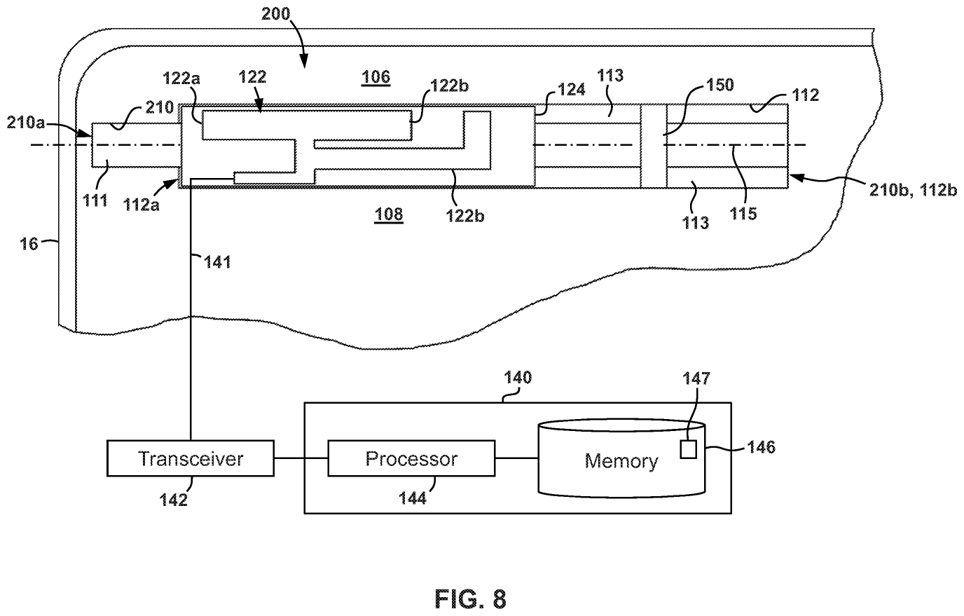

While examples described above have included a movable contact clip (e.g., contact clip 150) that is moved along an open slot (e.g., slot 110 having an open end 110a), the disclosed contact clips 150 may be utilized to adjust or tune an operating frequency of antenna that employs a so-called “closed slot” as previously described above. For instance, reference is now made to FIG. 8, which shows an antenna 200 that may be used within electronic device 10 in place of antenna 100. Antenna 200 is generally the same as antenna 100 shown in FIG. 2, except that antenna 200 includes a slot 210 in place of slot 110. All other features and components of antenna 200 that are shared with antenna 100 are identified in FIG. 8 with the same reference numerals. The slot 210 is also generally the same as slot 110, previously described, except that slot 210 is a so-called closed slot such that slot 210 extends along axis 115 between a first, closed end 210a and a second closed end 210b. The first closed end 210a may be defined by a conductive edge formed or defined within second housing member 16. During operations, the contact clip 150 may be moved along slot 210 so as to adjust an operating frequency of antenna 200 in the same manner described above for antenna 100. Thus, these operations are not repeated herein in the interest of brevity.

While examples disclosed herein have included a slot (e.g., slot 110, 210, etc.) formed in a conductive surface of a housing of an electronic device (e.g., conductive surfaces 106, 108 within second housing member 16 of electronic device 10 in FIG. 1), in other examples, an example antenna may include a slot formed in a conductive surface (e.g., a conductive plate) that is disposed within a housing of an electronic device. In some of these examples, the housing of the electronic device may comprise a non-conductive material (e.g., such as a polymer).

Therefore, the example slot antennas (e.g., antennas 100, 200, etc.) described herein include adjustable slot sizes so as to allow communication with a plurality of different potential wireless networks (e.g., wireless network 104) having various frequency bands. As a result, an electronic device (e.g., electronic device 10) incorporating the example antennas may achieve communication with any of a plurality of different potential wireless networks without housing multiple antennas having different slot sizes. Accordingly, through use of the disclosed example antennas, the design and manufacturing costs of such an electronic device may be reduced.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. An electronic device, comprising:
a housing; and
an antenna disposed within the housing, wherein the antenna comprises:
a slot extending between a first conductive surface and a second conductive surface; and
a contact clip coupled to the first conductive surface and the second conductive surface so that the first conductive surface is coupled to the second conductive surface through the contact clip,
wherein the contact clip is to move along the slot to adjust an operating frequency of the antenna.

2. The electronic device of claim 1, wherein the contact clip comprises a contact member that is biased into engagement the first conductive surface.

3. The electronic device of claim 2, wherein the contact member comprises a flat spring.

4. The electronic device of claim 2, wherein the contact clip comprises a second contact member that is biased into engagement with the second conductive surface.

5. The electronic device of claim 2, wherein the first conductive surface comprises a plurality of notches, wherein the contact member is to engage within the plurality of notches as the contact clip is moved along the slot.

6. An electronic device, comprising:
a housing; and
an antenna disposed within the housing, wherein the antenna comprises:
a slot extending between a first conductive surface and a second conductive surface; and
a contact extending between and coupled to the first conductive surface and the second conductive surface so that the first conductive surface is coupled to the second conductive surface through the contact,
wherein the contact is to move along the slot to adjust a size of the slot.

7. The electronic device of claim 6, wherein the first conductive surface is formed as a portion of the housing.

8. The electronic device of claim 6, wherein the contact is biased into engagement with the first conductive surface.

9. The electronic device of claim 8, wherein the first conductive surface comprises a plurality of notches, wherein the contact is to engage within the plurality of notches as the contact is moved along the slot.

10. The electronic device of claim 6, wherein the contact is biased into engagement with the second conductive surface.

11. The electronic device of claim 10, wherein the contact comprises a first flat spring and a second flat spring, wherein the contact is biased into engagement with the first conductive surface via the first flat spring and the contact is biased into engagement with the second conductive surface via the second flat spring.

12. The electronic device of claim 6, wherein the slot comprises an open slot.

13. The electronic device of claim 6, wherein the slot comprises a closed slot.

14. An electronic device, comprising:
a housing; and
an antenna disposed within the housing, wherein the antenna is to communicate with a wireless network and comprises:
a slot extending between a first conductive surface and a second conductive surface; and
a contact clip movably disposed within the slot and engaged with the first conductive surface and the second conductive surface, wherein the contact clip is to be transitioned along the slot, between a first position and a second position,
wherein when the contact clip is in the first position the antenna has a first operating frequency, and when the contact clip is in the second position the antenna has a second operating frequency that is different from the first operating frequency.

15. The electronic device of claim 14, wherein the contact clip comprises a pair of contact members that are biased into engagement with the first conductive surface and the second conductive surface.
